(19) United States
(12) Patent Application Publication
(10) Pub. No.: US 2026/0318321 A1
(43) Pub. Date: Oct. 15, 2026

(54) CASING FOR A ROTARY MACHINE

(71) Applicant: ARIANEGROUP SAS, Les Mureaux (FR)

(72) Inventor: Alain PYRE, Vernon Cedex (FR)

(73) Assignee: ARIANEGROUP SAS, Les Mureaux (FR)

(21) Appl. No.: 19/483,544

(22) PCT Filed: May 7, 2024
(86) PCT No.: PCT/FR2024/050606

§ 371 Date: Nov. 11, 2025

(30) Foreign Application Priority Data
May 12, 2023 (FR) FR2304749

(51) Int. Cl. F04D 29/42; B33Y 80/00

(52) U.S. Cl. CPC F04D 29/4206; B33Y 80/00

(57) ABSTRACT

A casing for a rotary machine, including a solid first wall delimiting an interior space of the casing, a solid second wall extending opposite the first wall on the outer side thereof, and a lacunary filling portion extending between the first wall and the second wall, wherein the first wall, the second wall and the filling portion are produced jointly and integrally by an additive manufacturing technique.

### TECHNICAL FIELD

The present disclosure relates to a casing for a rotary machine such as a pump, a compressor, a turbine or a machine comprising a plurality of modules of this or another type, in particular a turbomachine and in particular a turbopump.

A casing of this type for a rotary machine can be used, in particular, in the space or aeronautical industry, for example in a rocket engine or in the supply line of a space launcher. It can receive any type of fluid, gas or liquid, and in particular a propellant such as liquid hydrogen or liquid oxygen.

### PRIOR ART

In the space industry, and particularly in the field of space launchers, it is common practice to use propulsion systems based on at least one liquid propellant, in particular oxygen, hydrogen or methane. The supply line carrying this propellant from the propellant tank to the rocket engine comprises several types of hydraulic components. In particular, the supply line comprises at least one pump, generally a turbopump, able to compress the propellant in order that it can be supplied at the pressure expected by the rocket engine.

The casing of these turbopumps must have a high level of tightness so as not to degrade the efficiency of the turbopump and, above all, so as not to cause any leakage of propellant, which is generally highly dangerous, in particular because of the significant risk of ignition or explosion.

Moreover, the casings of these turbopumps have to withstand significant mechanical stresses due, firstly, to the pressure of the compressed propellant and, secondly, to the environment and operation of the launcher. In particular, in addition to radial forces, these casings also generate and are subjected to vibrations and significant bending forces, which can lead to catastrophic dynamic responses if they are not correctly managed.

As a result, the metal casings of known turbopumps are very thick, frequently comprising external stiffeners, and are therefore particularly heavy. This, of course, reduces the payload that the launcher can carry.

There is therefore a real need for a casing for a rotary machine that is free, at least in part, from the disadvantages inherent in the above-mentioned known configurations.

### DISCLOSURE OF THE INVENTION

The present disclosure relates to a casing for a rotary machine, comprising
a solid first wall delimiting an interior space of the casing,
a solid second wall extending opposite the first wall on its outside, and
a lacunary filling portion extending between the first wall and the second wall,
wherein the first wall, the second wall and the filling portion are produced jointly and integrally using an additive manufacturing technique.

It is understood here that the filling portion is connected directly to the first and second walls and that it comprises lacunae, i.e. voids, preferably macroscopic voids, distributed throughout the filling portion. Such a structure, including at least one lacunary portion, enables the mass of the casing to be significantly reduced, while maintaining sufficient mechanical strength and stiffness.

More specifically, in particular, the first wall, which is generally intended to be in contact with the pressurised fluid, remains solid, as does the second wall defining the outer casing envelope. Moreover, this structure, like a sandwich panel, enables a high bending moment of inertia to be obtained, reducing the risk of deformation of the casing and greatly limiting the dynamic response of the assembly.

The filling portion is sufficient to maintain the distance between the first wall and the second wall in the least loaded areas of the casing.

The use of an additive manufacturing technique advantageously makes it very easy to produce such a hybrid structure in a single operation. This type of additive manufacturing technique also enables the casing to be produced directly with a geometry, which may be complex, as close as possible to its final geometry, drastically reducing the need for subsequent machining stages.

In particular, it is understood here that the first wall can have any profile, with curved and/or flat portions; in particular, the first wall can comprise reversing portions, i.e. portions that extend backwards following portions extending in a given direction. The second wall can also have any profile, optionally different from that of the first wall.

In some embodiments, at least one portion of the first wall, and optionally the whole of the first wall, defines a portion of a duct for a fluid.

In some embodiments, the first wall is curved.

In some embodiments, the first wall is tubular. It is understood here that the first wall closes on itself in the form of a tube, without prejudging the shape of this tube: in particular, this tube need not be cylindrical and need not be rotationally symmetrical.

In some embodiments, the first wall is rotationally symmetrical. The axis of symmetry can then be the axis of rotation of the rotary machine.

In some embodiments, the first wall is cylindrical.

In some embodiments, the second wall is curved.

In some embodiments, the second wall is tubular and surrounds the first wall. In particular, it may be coaxial with the first wall. However, the second wall need not follow the profile of the first wall.

In some embodiments, the second wall is rotationally symmetrical. The axis of symmetry can then be the axis of rotation of the rotary machine.

In some embodiments, the second wall is cylindrical.

In some embodiments, the geometry of the second wall is different from the geometry of the first wall. In particular, the geometry of the second wall need not be derived from the geometry of the first wall by simple enlargement.

In some embodiments, the thickness of the second wall is between 30% and 200%, preferably between 30% and 99%, of the thickness of the first wall. The second wall can be thinner than the first wall because it is subject to lower radial stresses than the first wall. Its thickness can be chosen to ensure satisfactory bending inertia.

In some embodiments, the distance between the first wall and the second wall is variable along the first wall. This distance is measured radially with respect to a main axis, this main axis being the central axis of the first wall when the latter is tubular.

In some embodiments, the distance between the first wall and the second wall is at least 300%, preferably at least 500%, of the thickness of the first wall. Preferably, this is verified at any point on the first wall. The bending moment of inertia of the casing is thus increased.

In some embodiments, the lacuna ratio in the filling portion is at least 20%, preferably at least 50%, more preferably at least 80% or even at least 90%. The lacuna ratio is defined here as the ratio of the cumulative volume of voids included in the filling portion to the total volume occupied by the filling portion.

In some embodiments, the filling portion has a cellular, columnar or lattice structure. This structure may or may not be regular, in terms of the geometry and/or size of the lacunae.

In some embodiments, the filling portion occupies at least 50%, preferably at least 80%, more preferably at least 90%, of the volume defined between the first and second walls. This thus helps to maintain the distance between the two walls throughout the casing.

In some embodiments, the casing comprises at least one vacant portion between the first wall and the second wall, this vacant portion having no filling. Such a vacant portion can be used to install an accessory inside the casing or to accommodate the passage of a supply line, such as a pipe. Such a portion can also further reduce the mass of the assembly.

In some embodiments, said at least one vacant portion is partially, preferably entirely, bordered by a solid border wall. Such a border wall makes it possible to close off the vacant portion in order, for example, to allow a fluid to pass through. This vacant potion may be curved, optionally toroidal or partially toroidal.

In some embodiments, the casing comprises at least one attachment flange provided along an edge of the first wall and/or the second wall.

In some embodiments, said at least one attachment flange extends between an edge of the first wall and an opposing edge of the second wall.

In some embodiments, the casing comprises at least one solid reinforcing wall extending outwardly from the first wall. This reinforcing wall enables the casing, and in particular the first wall, to be locally reinforced against local forces.

In some embodiments, at least one reinforcing wall extends to the second wall. Such a reinforcing wall then helps to maintain the distance between the first wall and the second wall.

In some embodiments, at least one reinforcing wall extends to an attachment flange.

In some embodiments, the thickness of the reinforcing wall is at least 100%, preferably at least 200%, of the thickness of the first wall.

In some embodiments, at least one dust removal hole is provided in the second wall. Such a dust removal hole enables the unsolidified material corresponding to the lacunae in the filling portion to be removed after additive manufacturing.

In some embodiments, the casing is made of metal, preferably selected from the group consisting of nickel-based alloys, aluminium-based alloys, titanium-based alloys and steels. The casing can be made of Inconel 625 or Inconel 718 (registered trademarks).

Within the meaning of the present disclosure, an alloy is considered to be based on a given element when this element is the main element in the composition of this alloy, advantageously when this element is present in a higher content than the other components, even more advantageously in a content of at least 50% in molar percentage, even more advantageously of at least 60% in molar percentage.

The present disclosure also relates to a rotary machine, comprising a casing according to any of the preceding embodiments.

In this disclosure, the terms “axial”, “radial”, “tangential”, “interior”, “exterior” and their derivatives are defined in relation to the main axis of the rotary machine; “axial plane” shall mean a plane passing through the main axis of the rotary machine and “radial plane” a plane perpendicular to this main axis.

The above mentioned features and advantages, and others, will become apparent on reading the detailed description which follows, of exemplary embodiments of the proposed casing for a rotary machine. This detailed description refers to the attached drawings.

### BRIEF DESCRIPTION OF THE DRAWINGS

The attached drawings are schematic and primarily aim to illustrate the principles of the disclosure.

FIG. 1 is an axial cross-sectional view of a casing for a rotary machine.

### DESCRIPTION OF THE EMBODIMENTS

In order to make the disclosure more concrete, an example of a casing for a rotary machine is described in detail below, with reference to the attached drawings. It is recalled that the invention is not limited to this example.

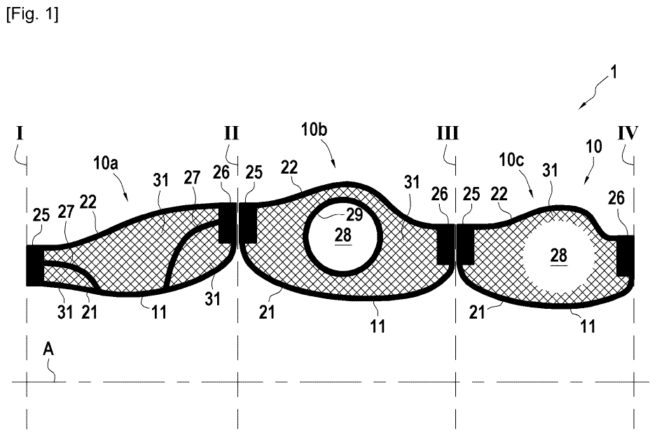

FIG. 1 shows a cross-section of the casing 10 of a rotary machine 1 in a plane passing through its main axis A. This casing 10 comprises three casing sections 10a, 10b, 10c, which are generally tubular, coaxial and assembled one in the extension of the other.

Each casing section 10a, 10b, 10c comprises a first wall 21, which is solid and sealed, tubular and rotationally symmetrical about the main axis A. The first wall 21 extends axially from upstream to downstream between an upstream radial plane and a downstream radial plane: the first wall 21 of the first casing section 10a thus extends between a first radial plane I and a second radial plane II; the first wall 21 of the second casing section 10b extends between the second radial plane II and a third radial plane III; and the first wall 21 of the third casing section 10c extends between the third radial plane III and a fourth radial plane IV. The first wall 21 thus defines a duct 11 through which a fluid, for example a cryogenic propellant such as liquid hydrogen or liquid oxygen, is intended to flow. In a cryogenic example, this fluid can have a temperature of order 20K to 80K and a pressure of order 100 to 200 bar. However, in other examples, the temperature of the fluid could rise to 1000K and its pressure to 300 bar.

Each casing section 10a, 10b, 10c also comprises a second wall 22, which is solid, tubular and rotationally symmetrical about the main axis A. The second wall 22 extends axially from upstream to downstream between the upstream radial plane I, II, III and the downstream radial plane II, III, IV of the relevant casing section 10a, 10b, 10c. The axial cross-sectional profIIe of the second wall 22 does not necessarlly correspond to the axial cross-sectional profile of the first wall 21. On the other hand, the radial distance between the first wall 21 and the second wall 22 is at least equal to 500% of the thickness of the first wall 21 at any point on the first wall 21.

Each casing section 10a, 10b, 10c further comprises an annular radial upstream closure wall 25 extending between the first wall 21 and the second wall 22 at its upstream radial plane I, II, III. SimIIarly, each casing section 10a, 10b, 10c comprises a radial annular downstream closure wall 26 extending between the first wall 21 and the second wall 22 at its downstream radial plane II, III, IV. The upstream closure wall 25 and the downstream closure wall 26 also form attachment flanges enabling the casing sections 10a, 10b, 10c to be joined together or the casing 10 to be attached to other upstream and/or downstream components.

The first and second walls 21, 22 are solid and made of metal, preferably a nickel-based alloy such as Inconel 625 or Inconel 718 (registered trademarks).

In contrast, the volume between the first wall 21 and the second wall 22 is occupied by a lacunary filling material forming one or more filling portions 31. These filling portions 31 are thus occupied by a lattice structure with a lacuna ratio of at least 80%.

However, this volume between the first wall 21 and the second wall 22 may also include other structures. In particular, the first casing section 10a comprises solid reinforcement walls 27 passing through part of this volume. In the present example, a first reinforcing wall 27 extends in a curved manner between the upstream closure wall 25 and the first wall 21, and a second reinforcing wall 27 extends in a curved manner between the downstream closure wall 26 and the first wall 21.

The second casing section 10b comprises, between its first wall 21 and its second wall 22, a vacant portion 28 with no filling material and delimited by a solid border wall 29. In particular, the volume of this vacant portion 28 may be traversed by a fluid, identical or different to that traversing the duct 11.

The third casing section 10c also comprises, between its first wall 21 and its second wall 22, a vacant portion 28 but, unlike the case of the second casing section 10b, this vacant portion 28 has no border wall; this vacant portion 28 is therefore simply defined by a local absence of the filling material 31.

The filling portions 31 are made of the same material as the solid walls of the casing 10. More specifically, all the walls 21, 22, 25, 26, 27, 29 of a given casing section 10a, 10b, 10c, as well as the filling potions 31 of this casing section 10a, 10b, 10c, are produced simultaneously during the same additive manufacturing step.

Although the present invention has been described by referring to specific exemplary embodiments, it is obvious that modifications and changes can be made to these examples without going beyond the general scope of the invention as defined by the claims. In particular, the individual features of different embodiments IIlustrated or mentioned can be combined in additional embodiments. Consequently, the description and the drawings should be considered as illustrating rather than limiting.

It is also obvious that all the features described in reference to a method can be transposed, alone or in combination, to a device, and inversely, all the features described in reference to a device can be transposed, alone or in combination, to a method.

1. A casing for a turbopump rotary machine, comprising
a solid first wall delimiting an interior space of the casing, at least one portion of said first wall defining a cryogenic propellant duct portion,
a solid second wall extending opposite the first wall on the outer side thereof, and
a lacunary filling portion extending between the first wall and the second wall,
wherein the first wall, the second wall and the filling portion are produced jointly and integrally by an additive manufacturing technique.

2. The casing for a rotary machine according to claim 1, wherein the first wall is rotationally symmetrical.

3. The casing for a rotary machine according to claim 1, wherein the geometry of the second wall is different from the geometry of the first wall.

4. The casing for a rotary machine according to claim 1,
wherein the distance between the first wall and the second wall is variable along the first wall, and
wherein the distance between the first wall and the second wall is at least 300%, preferably at least 500%, of the thickness of the first wall.

5. The casing for a rotary machine according to claim 1, wherein the filling portion has a cellular, columnar or lattice structure.

6. The casing for a rotary machine according to claim 1, wherein the filling portion occupies at least 50%, preferably at least 80%, more preferably at least 90%, of the volume defined between the first and second walls.

7. The casing for a rotary machine according to claim 1, comprising at least one vacant portion between the first wall and the second wall, this vacant portion having no filling.

8. The casing for a rotary machine according to claim 7, wherein said at least one vacant portion is at least partially bordered by a solid border wall.

9. The casing for a rotary machine according to claim 1, comprising at least one attachment flange provided along an edge of the first wall and/or of the second wall
wherein said at least one attachment flange extends between an edge of the first wall and a facing edge of the second wall.

10. The casing for a rotary machine according to claim 1, comprising at least one solid reinforcing wall extending outwards from the first wall, the at least one reinforcing wall extending to the second wall or to an attachment flange.

11. The casing for a rotary machine according to claim 1, wherein the casing is made of metal, preferably selected from the group consisting of nickel-based alloys, aluminium-based alloys, titanium-based alloys and steels.

12. A rotary machine comprising a casing according to claim 1.
